(19) United States
(12) Patent Application Publication
(10) Pub. No.: US 2004/0066788 A1
(43) Pub. Date: Apr. 8, 2004

(54) Virtual subnet controller and controlling method thereof

(75) Inventors: Por-Horng Lin, Hsinchu (TW); Ying-Tsai Hsu, Hsinchu (TW)

Correspondence Address: CONNOLLY BOVE LODGE & HUTZ LLP, SUITE 800, 1990 M STREET NW, WASHINGTON, DC, 20036-3425, US

(73) Assignee: Handlink Technologies Inc., Hsinchu (TW)

(21) Appl. No.: 10/657,104

(22) Filed: Sep. 9, 2003

(30) Foreign Application Priority Data
Sep. 30, 2002 (TW) 091122587

(51) Int. Cl. H04L 12/56

(52) U.S. Cl. 370/401; 370/474

(57) ABSTRACT

A virtual subnet controller includes a subnet mapping table and a control unit. When the source and destination stations belong to a public network and a private network, respectively, the NAT protocol is used for converting the IP address of the data packet. After receiving the ARP request froma source station, the virtual subnet controller will respond with an ARP response, enabling the data packet transmitted from the source station.

### BACKGROUND OF THE INVENTION

(A) Field of the Invention

The present invention relates to a virtual subnet controller and its controlling method, particularly to a controller and its controlling method capable of performing data packet transmission between stations in subnets.

(B) Description of Related Art

To solve the increasing problem of insufficient number of public IP addresses, RFC1918 defines three ranges of private IP addresses, which are 10.0.0.0˜10.255.255.255, 172.16.0.0˜172.31.255.255, and 192.168.0.0˜192.168.255.255. The private IP addresses can be used in computers within enterprises without any additional procedure for applying for public IP addresses. Besides, because the plurality of private IP addresses are converted to one public IP address when packets are transmitted into the external public network, many IP addresses can be saved well. However, on the contrary, because the same public IP address is shared by the plurality of private IP addresses, the data packet transmission between the public network and the private network within enterprises needs to rely on a router for converting IP addresses.

A commonly used conversion method between private IP addresses and public IP addresses is called Network Address Translation (NAT), as defined by RFC1631. The NAT router replaces the source address contained in the IP header of the data packets from the private network with a public IP address for entering the public network, replaces the source address contained in the IP header of the data packets from the public network with a private IP address for entering the private network.

Nevertheless, the NAT router cannot send the packets from the stations having public IP addresses in the private network into the public network.

U.S. Pat. No. 6,130,892, entitled “Nomadic Translator or Router,” discloses a translator being capable of converting data packet of stations that contain public IP addresses into the address of the translator, and then redirecting it to the public network. Likewise, after receiving the data packet sent from the public network, the translator converts the address into the address of the translator, and then redirects it to the stations that contain public IP addresses.

However, the translator disclosed by the above-mentioned U.S. patent is only applicable on one or several portable stations, and uses a connection such as Hub for connecting the translator and the portable stations. Afterwards, the translator is connected to a private network, and then, by means of a router, to a public network. In other words, the translator does not function as a router between the public network and private network, nor does it function as an administrator between stations in networks and subnets. Therefore, the prior art translator cannot fully meet the demands of the industries nowadays.

### SUMMARY OF THE INVENTION

The main objective of the present invention is to provide a virtual subnet controlling method and its controller, which is capable of sending data packets between stations within the same or different subnets.

The second objective of the present invention is to provide a virtual subnet controlling method and its controller, which is capable of sending data packets between stations in public networks and private networks.

The third objective of the present invention is to provide a virtual subnet controlling method and its controller that can maintain privacy of transmission.

To fulfill the above-mentioned objectives while preventing the drawbacks of the prior art, the present invention discloses a virtual subnet controlling method, using a virtual subnet controller for connecting the public networks and the private network. The private network comprises at least a subnet, and the method includes Procedures (a) through (e). In Procedure (a), a first station broadcasts an ARP request. In Procedure (b), if the destination station of the ARP request is a second station which is located in the same subnet as the first station, the second station responds with an ARP response. In Procedure (c), the virtual subnet controller responds with an ARP response. In Procedure (d), the first station sends the data packet to the virtual subnet controller. In Procedure (e), the virtual subnet controller sends the data packet to the destination station.

The virtual subnet controller of the present invention connects, on its two ends, respectively, to a public network and a private network containing at least one subnet, and the virtual subnet controller has two features: Feature (a)—containing a subnet mapping table, when the source and destination stations belong to a public network and a private network, respectively, the NAT protocol being used for converting the IP address of the data packet; and Feature (b)—after receiving the ARP request from a source station, the virtual subnet controller will respond with an ARP response, enabling the data packet transmitted from the source station to the virtual subnet controller, and then redirecting it to the destination station.

### BRIEF DESCRIPTION OF THE DRAWINGS

The present invention will be described according to the appended drawings in which:

FIG. 1 shows a preferred embodiment of the virtual subnet controller according to the present invention;

FIG. 2 shows the ARP table of a station according to the present invention; and

FIG. 3 shows another preferred embodiment of the virtual subnet controller according to the present invention.

### DETAILED DESCRIPTION OF PREFERRED EMBODIMENT

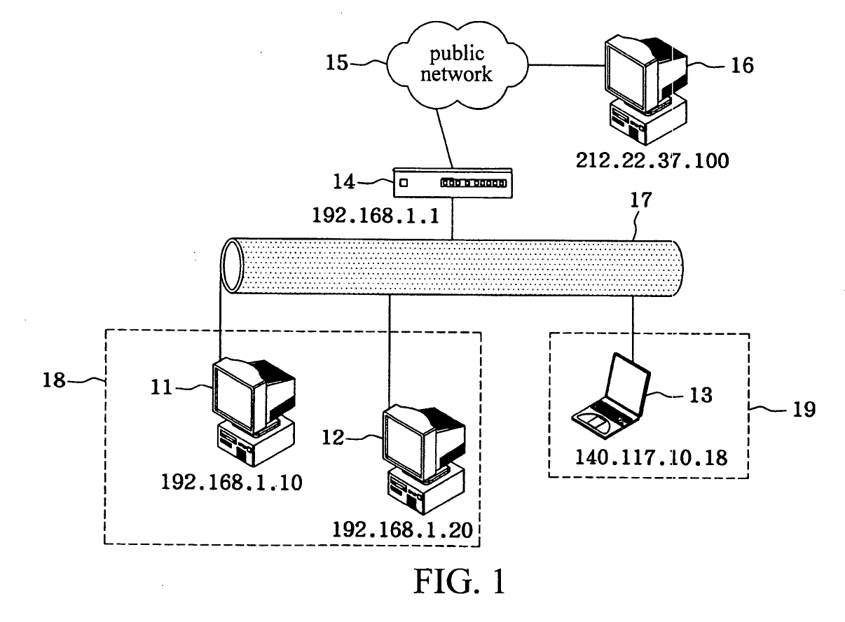

FIG. 1 illustrates a system diagram of the virtual subnet controller of the present invention. The virtual subnet controller 14 connects, on its both ends, respectively, to a public network 15 (such as the Internet) and a private network 17 (such as Ethernet or LAN). The other end of the public network 15 connects to a fourth subnet 16. The other end of the private network 17 connects to a first station 11, a second station 12, and a third station 13, wherein the first station 11 and the second station 12 belong to a first subnet 18, and the third station belongs to a second subnet 19.

When the first station 11 (source station) intends to transmit data packet with the second station 12 (destination station) within the same subnet, if the MAC address of the second station 12 does not exist in the ARP table of the first station 11, the first station first broadcasts an ARP request for seeking the MAC address of the second station 12. Due to the second station 12 and the first station 11 being located in the same subnet, the second station 12 will receive the ARP request of the first station 11 and responds with an ARP response that contains its MAC address. Awaiting a time period after the response of the second station, the virtual subnet controller 14 will send the response packet that contains the MAC address to the first station 11 for overriding the ARP response of the second station 12. As a result, when the first station 11 intends to transmit data packets with the second station 12 afterwards, the first station 11 will send data packets first to the virtual subnet controller 14, and then redirect it to the second station 12.

The control algorithm of the virtual subnet control according to the first embodiment of the present invention is described as follows:

First station (denoted by Station_A): containing a private IP address;

Second station (denoted by Station_B): containing a private IP address, while being located at the same subnet as Station_A;

The virtual subnet controller (Router_H);

If [Station_B's MAC, Station_B's IP] entry does not exist in the ARP table of Station_A, Station_A broadcasts an ARP request packet to the network;

Station_B receives the ARP request packet of Station_A and sends an ARP Response packet to Station_A;

Station_A updates its ARP table;

Router_H has to wait for a time period until that Station_A receives the ARP Response packet of Station_B. After that, Router_H sends an ARP Response to Station_A with [Router_H's MAC, Station_B's IP];

Station_A receives Router_H's ARP Response and updates its ARP table to replace Station_B's MAC with Router_H's MAC in the ARP table;

Station_A sends data packet to Router_H;

Router_H checks if the destination IP of Station_A is in virtual subnet mapping table;

If the entry does exist and is matched, Router_H redirects the data packet of Station_A to Station_B;

If [Station_B's MAC, Station_B's IP] entry exists in the ARP table of Station_A and Station_A sends data packet to Station_B, Router_H will capture the data packet, update its virtual subnet mapping table and send an ARP request packet with [Router_H's MAC, Station_B's IP] to Station_A;

Station_A receives the ARP request packet and update its ARP table; and

Station_A sends data packet to Router_H instead of Station_B.

When the first station 11 intends to transmit data packets with a third station 13 not within the same subnet, if the first station does not know the MAC address of the third station 13, the first station first broadcasts an ARP request for seeking the MAC address of the third station 13. Due to the third station 13 and the first station 11 being not located in the same subnet, the third station 13 will not respond to the ARP request of the first station 11. At the moment, the virtual subnet controller 14 sends the ARP response that contains the MAC address to the first station 11. As a result, when the first station 11 intends to transmit data packets with the third station 13 afterwards, the first station 11 will send the data packets first to the virtual subnet controller 14, and then redirect them through the virtual subnet controller 14 to the third station 13.

The control algorithm of the virtual subnet control according to the second embodiment of the present invention is described as follows:

first station (denoted by Station_A): containing a private IP address;

third station (denoted by Station_C): containing a private (or public) IP address, while being located at a different subnet from the first station;

The virtual subnet controller (Router_H);

Station_A communicates with Station_C;

Station_A broadcasts an ARP request packet to the network;

Router_H receives the ARP request packet of Station_A and sends an ARP Response packet to Station_A;

Station_A receives the ARP Response packet of Router_H with Router_H's MAC and updates its ARP table;

Station_A sends data packet to Router_H;

Router_H checks if the destination IP of Station_A is in virtual subnet mapping table; and

If the entry exists and is matched, Router_H redirects the data packet of Station_A to Station_C.

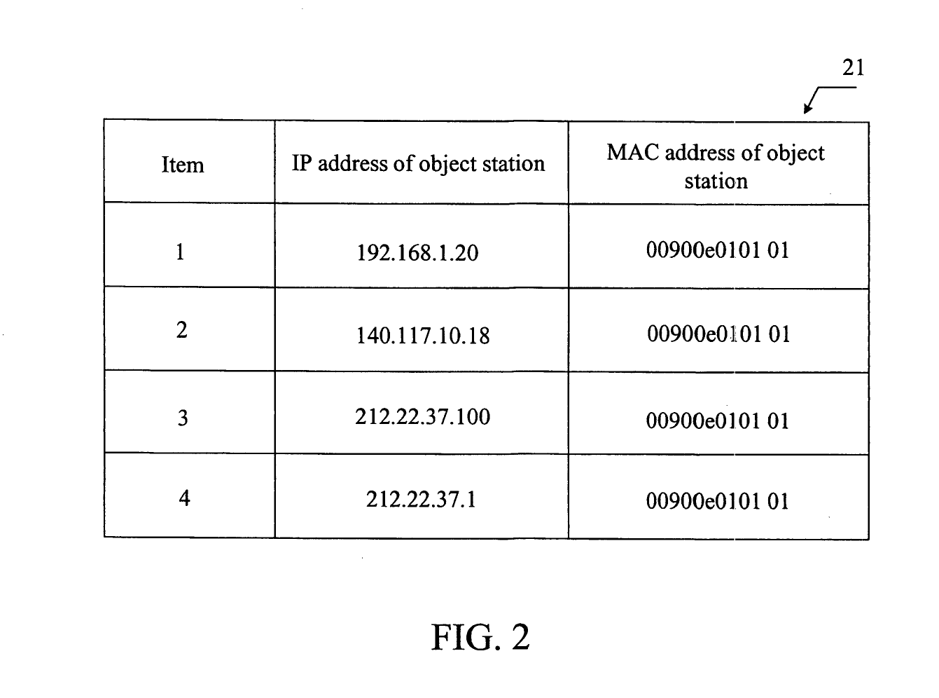

FIG. 2 illustrates the ARP table 21 of first station 11, which comprises IP address fields of the destination stations and the MAC address fields of the destination stations. As the transmission targets of the ARP table 21 all direct to the virtual subnet controller 14 (00900e010101), no matter what the destination stations are, the first station 11 will send data packet first to the virtual subnet controller 14, and then redirect the packets through the virtual subnet controller 14 to other stations.

When a virtual subnet is created, the virtual subnet controller 14 will create a subnet mapping table 31 within itself, and the subnet mapping table 31 will contain a MAC address and IP address, so as to avoid the situations of being unable to identify stations that are located in different subnets but containing the same IP addresses.

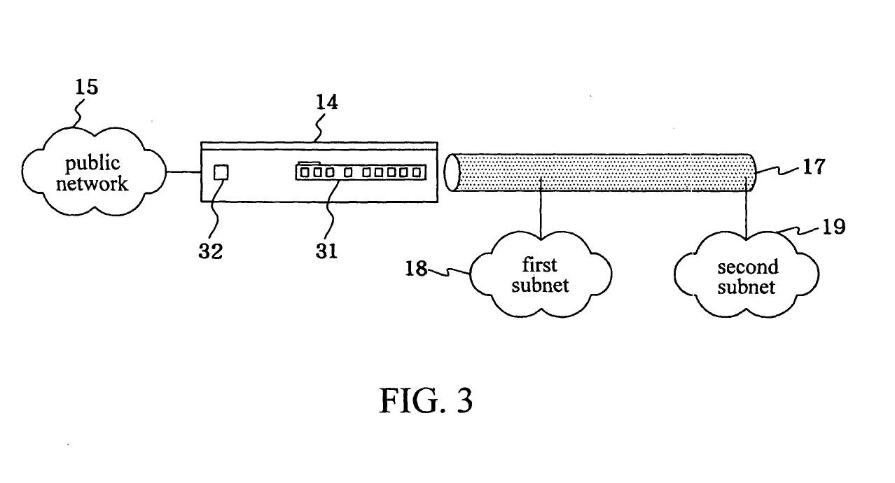

Please refer to FIG. 3. When the virtual subnet controller 14 receives a data packet from a public network, if the destination IP address of the data packet is recorded in the subnet mapping table 31, the virtual subnet controller 14 uses NAT protocol to convert the destination IP address of the data packet into a private IP address. Otherwise, when stations in the subnet intends to send a data packet to a public network, the virtual subnet controller 14 uses NAT protocol to convert the source IP address of the data packet into a public IP address. The virtual subnet controller 14 comprises a control unit 32, which responds with an ARP response and enables the data packet transmitted from the source station to the virtual subnet controller, and then redirects the data packets to the destination station after receiving the ARP request from a source station.

The control algorithm of the virtual subnet control according to the third embodiment of the present invention is described as follows:

Fourth subnet (denoted by Station_D): containing a public IP address, while connecting to public network;

The virtual subnet controller (Router_H);

Station_A broadcasts an ARP request packet to the network;

Router_H receives the ARP request of Station_A and sends an ARP Response to Station_A;

Station_A receives the ARP response of Router_H with Router_H's MAC and updates its ARP table;

Station_A sends data packet to Router_H;

Router_H checks if the destination IP of Station_A is in virtual subnet mapping table; and

Because the entry does not exist, the Router_H redirects the data packet of Station_A to Station_D by using NAT.

In FIG. 3, when the stations within a private network intend to transmit data packets, the virtual subnet controller 14 does not use NAT protocol, but assists in the transmission of the data packets among subnets instead. In other words, no matter whether it is the stations within the same or different subnets that intend to transmit data packets, the transmission can be served through the assistance of the virtual subnet controller 14.

The above-described embodiments of the present invention are intended to be illustrative only. Numerous alternative embodiments may be devised by those skilled in the art without departing from the scope of the following claims.

What is claimed is:

1. A virtual subnet controlling method, which utilizes a virtual subnet controller to connect a public network and a private network including at least one subnet, the method comprising the steps of:
broadcasting an ARP request by a first station;
responding an ARP response by a second station if the second station is the destination station of the ARP request and is located at the same subnet as the first station;
responding an ARP response by the virtual subnet controller;
transmitting data packets from the first station to the virtual subnet controller; and
transmitting data packets from the virtual subnet controller to the second station.

2. The virtual subnet controlling method of claim 1, further comprising a step of converting an IP address by a NAT protocol if the destination station is connected to the public network.

3. The virtual subnet controlling method of claim 1, wherein the virtual subnet controller awaits a time period and then responds with an ARP response to the first station after the second station responds an ARP response to the first station, so as to override the ARP response from the second station to the first station.

4. The virtual subnet controlling method of claim 1, wherein the the first station records the ARP response in its ARP table when the ARP response is received.

5. A virtual subnet controlling method, which utilizes a virtual subnet controller to connect a public network and a private network including at least one subnet, the method comprising the steps of:
updating the destination of data packets in an ARP table of a source station as the IP address of the virtual subnet controller;
transmitting the data packets from the source station to the virtual subnet controller; and
transmitting the data packets from the virtual subnet controller to the destination station.

6. The virtual subnet controlling method of claim 5, further comprising a step of converting an IP address by a NAT protocol if the destination station is connected to the public network.

7. A virtual subnet controller, connected to a public network and a private network including at least one subnet, the virtual subnet controller comprising:
a subnet mapping table, which uses NAT protocol to convert IP addresses of data packets if source and destination stations belong to a public network and a private network, respectively; and
a control unit, which responds with an ARP response and enables the data packets transmitted from the source station to the virtual subnet controller, and then redirects the data packets to the destination station.

8. The virtual subnet controller of claim 7, wherein the virtual subnet controller awaits a time period and then responds with an ARP response to the source station after the destination station responds with an ARP response to the source station, so as to override the ARP response from the destination station to the source station.
